(19) United States
(12) Patent Application Publication
(10) Pub. No.: US 2024/0346522 A1
(43) Pub. Date: Oct. 17, 2024

(54) SYSTEM, PLATFORM, AND METHOD FOR HIERARCHICALLY LINKED SMART CONTRACTS AND TOKENIZED VERIFICATION

(71) Applicant: Seekr, LLC, Laguna Beach, CA (US)

(72) Inventor: Morgan Stone, Laguna Beach, CA (US)

(21) Appl. No.: 18/617,919

(22) Filed: Mar. 27, 2024

Related U.S. Application Data
(60) Provisional application No. 63/492,774, filed on Mar. 28, 2023.

(51) Int. Cl. G06Q 30/018; G06Q 10/1053; H04L 9/32

(52) U.S. Cl. CPC G06Q 30/018; G06Q 10/1053; H04L 9/3213

(57) ABSTRACT

A platform may generate a plurality of smart contracts corresponding to a hierarchical structure, each of the plurality of smart contracts being configured for on-chain association between various organizations. The platform may define, for each of the plurality of smart contracts, one or more triggering events for deployment via a blockchain protocol, and one or more parameters for minting one or more Soul Bound Tokens (“SBTs”). Each SBT may be associated with one of the following: a job hiring, a review, or another business project. The platform may, responsive to receiving an indication that the one or more triggering events have occurred, identify a recipient blockchain address associated with the one or more triggering events, and deploy one or more of the plurality of smart contracts onto the recipient blockchain address corresponding to a user associated with the one or more triggering events.

### RELATED APPLICATION

Under provisions of 35 U.S.C. § 119 (e), the Applicant claims benefit of U.S. Provisional Application No. 63/492,774 filed on Mar. 28, 2023, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to smart contracts, blockchain verification, and soulbound tokens, and more specifically to use of soulbound tokens for employment verification.

### BACKGROUND

Verifying former employment, skills, and certifications claimed on resumes can be difficult. For example, when an employer reviews a resume of an applicant, they have limited verification capabilities. Some capabilities may include calling the former employer. This may cause problems because employers can be hesitant to divulge information about a former employee due to various labor laws and/or the desire to keep proprietary or personal information private. Even if an employer can verify an applicant worked at a certain company, they may be unable to verify whether the employee worked at the position they claim, how long employment lasted, or if the applicant possesses the skills they claim. Accordingly, there is a need for a simple, effective, and secure means to track and verify employment, completed projects, certifications, and/or positions at employers and former employers.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Soulbound tokens (SBTs) provide a basis for a decentralized society (DeSoc), which is a co-determined sociality in which communities and Souls come together bottom-up as emergent features of one another to co-create plural network goods and bits of intelligence at various scales. A soulbound token is a publicly verifiable and non-transferable nonfungible token (NFT) that represents an individual's credentials, affiliations and commitments.

Non-transferable tokens refer to NFTs that can help track reputation and are added to addresses but cannot be moved. But what does “Souls” refer to in soulbound NFTs? The wallets or accounts to which SBTs or non-transferable tokens are permanently bound are called Souls. For instance, a Soul can represent an individual's employment history, which can be self-certified similar to information in one's curriculum vitae or resume.

However, when SBTs possessed by one Soul are issued or attested by other Souls who are counterparties (e.g., individuals and/or organizations) to these relationships. That is, when the mechanism's true power is revealed. For instance, the Ethereum Foundation might be a Soul that awards SBTs to those who attended an Ethereum conference. In this way, it can be known that the Ethereum Foundation has certified that the recipient of such a token was an attendee of the conference.

The concept of “plural network groups” refers to interactions and communications within the networks and are the most critical drivers of economic growth. For example, an artists may get rid of dishonest individuals selling NFT collections under the guise of famous artists by linking soulbound tokens to their artistic profile. SBTs would allow buyers to trace the social provenance of a work, and blockchain inclusion enables the buyers to track when a specific work was created.

For instance, a tradeable NFT could be issued by an artist from their Soul to help buyers recognize an artist's work by the number of soulbound tokens it contains, establishing the legitimacy of the nonfungible token. As a result, Souls would develop a publicly verified, on-chain method for staking, and develop a reputation around the provenance and rarity of an item.

Soulbound tokens may also be used to represent a candidate's educational credentials, like a degree and/or a professional certification. Additionally or alternatively, SBTs may represent previous work history. In this way, SBTs can be used as proof of skill of the holder of those SBTs to meet human resource needs of an organization.

A user's blockchain activity can be tracked using SBTs, which can be converted into non-transferable reputation tokens inside game avatars that can only be leveled up in this method. This means that a user can level up by being a good Web3 citizen (instead of playing the game), giving the user avatar non-transferable skills and experience.

Traditional credit reports may also be represented by SBTs, giving lenders access to a borrower's whole credit profile. For example, an SBT indicating a debt owed by a user may be issued when the debt is incurred; the SBT may be replaced by payment documentation or deleted once the loan has been repaid. As a result, people cannot hide their ongoing financial obligations.

Web3 has been mainly dependent on token sales or airdrops to entice new communities, but both methods provide mediocre results. As an alternative, Souldrops can be issued using SBTs. As an example, a Souldrop may allow developers with 5 out of the last 10 conference attendance to receive soulbound token(s) serving as a proof of attendance protocol (POAP). People can use POAPs, a special NFT, to demonstrate that they attended a live or recorded event.

One of the advantages of using soulbound tokens for credential verification purposes is that, since information is permanently replicated on the blockchain, no one can falsify it. Moreover, any awards and certificates earned by an individual can be publicly verifiable via the SBTs. Furthermore, since SBTs cannot be purchased, the authenticity of the SBTs cannot be questioned, allowing the SBTs to foster confidence among token holders and the general public that the token holders are deserving of their tokens.

In some embodiments, protocols may check a borrower's credit history and/or evaluate associated credit score(s) to determine how much the borrower may be permitted to access based on soulbound NFTs. SBTs may be used to restrict blockchain projects from becoming a cash grab by making digital representations non-tradable. That is, an individual cannot buy SBTs; instead, the individual must put effort into earning them.

In one aspect, the present disclosure provides a method for integrating hierarchically linked smart contracts with tokenized verification, the method comprising: generating a plurality of smart contracts corresponding to a hierarchical structure, each of the plurality of smart contracts being configured for on-chain association between one or more of the following: a business parent, a business subsidiary, a business, a business division, a business department, a business team, and a business project, for each of the plurality of smart contracts, defining the following: one or more triggering events for deployment via a blockchain protocol, and one or more parameters for minting one or more Soul Bound Tokens (“SBTs”), each of the one or more SBTs being associated with one of the following: a job hiring, a review, and another business project; receiving an indication that the one or more triggering events have occurred; identifying a recipient blockchain address associated with the one or more triggering events; and deploying one or more of the plurality of smart contracts onto the recipient blockchain address associated with a user having performed the one or more triggering events.

In some aspects, the techniques described herein relate to a blockchain-based employment verification system including a plurality of self-identifying project-factory smart contracts configured to generate subsidiary-level token collection contracts and a token issuance module configured to issue Soul Bound Tokens (SBTs) that associate one or more employees with their respective job descriptions and job durations. A verification module may be configured to track information associated with employee affiliation and employee role for a company based at least in part on the issued SBTs. The system may be configured to accommodate one or more hierarchical structures for each company.

In some aspects, the techniques described herein relate to a non-transitory computer-readable medium including instructions that, when executed by a hardware processor, cause performance of operations for integrating hierarchically linked smart contracts with tokenized verification. The operations may include generating a plurality of smart contracts corresponding to a hierarchical structure, each of the plurality of smart contracts being configured for on-chain association between one or more of the following: a business parent, a business subsidiary, a business, a business division, a business department, a business team, and a business project. For each of the plurality of smart contracts, one or more triggering events for deployment via a blockchain protocol, and one or more parameters for minting one or more Soul Bound Tokens (“SBTs”) may be defined. Each of the one or more SBTs may be associated with a job hiring, a review, or another business project. Responsive to receiving an indication that the one or more triggering events have occurred, a recipient blockchain address associated with the one or more triggering events may be identified. One or more of the plurality of smart contracts may be deployed onto the recipient blockchain address corresponding to a user associated with the one or more triggering events.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2A illustrates a first portion of an operating environment for a company creation module 200;

FIG. 2B illustrates a second portion of the operating environment for the company creation module 200;

FIG. 2C illustrates a third portion of the operating environment for the company creation module 200;

FIG. 2D illustrates a fourth portion of the operating environment for the company creation module 200;

FIG. 3A illustrates a first portion of an operating environment for a job lifecycle module 300;

FIG. 3B illustrates a second portion of an operating environment for a job lifecycle module 300;

FIG. 3C illustrates a third portion of an operating environment for a job lifecycle module 300;

FIG. 4 illustrates an operating environment for an API module 400;

FIG. 5 illustrates an operating environment for a token generation module 500;

FIG. 6 is a flow chart of a method 1000 for integrating hierarchically linked smart contracts with tokenized verification; and

FIG. 7 is a block diagram of a system including a computing device 900.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings.

Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of smart contracts, blockchain verification, and soul sound tokens, embodiments of the present disclosure are not limited to use only in this context.

### I. PLATFORM OVERVIEW

This overview is provided to introduce a selection of concepts in a simplified form that are further described below. This overview is not intended to identify key features or essential features of the claimed subject matter. Nor is this overview intended to be used to limit the claimed subject matter's scope.

The present disclosure connects companies and their subsidiaries with job seekers in order to build an on-blockchain, immutable resume that simplifies work history verification, reduces fraud, and reduces friction.

To track employment data, companies generate self-identifying project-factory smart contracts which produce subsidiary-level token collection contracts through which Soul Bound Tokens (SBTs) associate an employee, the job description(s) of the employee, and the job duration(s) of the employee, with their employer. In this way, the affiliation of each employee and the role of the employee for the company is tracked with one or more SBTs.

Although this description is written on the basis of Parent Company and its subsidiaries, it should be noted, for example, that any hierarchy (not limited to parent/subsidiary) is suitable. As one alternative example, the hierarchy may be one of company, division, department, team, and/or project.

Each entity in a system can be associated with on-chain ratings and reviews, aggregating to form a job seeker's employment history and a synopsis of a company's reputation as an employer.

Employment tracked outside of the present invention can be populated onto the blockchain via a peer-to-peer employer-employee verification workflow with manual intervention where necessary.

The present invention's structure tracks both companies and one level of entities beneath them (we call them projects, like KFC™ under Yum Brands™ or LinkedIn™ under Microsoft™). The present disclosure further allows for specificity while still allowing a user to prove their employment under a larger entity. This would enable our users, for example, to work for AWS™, but on-chain prove that they have a token issued indirectly by Amazon™ itself.

Embodiments of the present disclosure may comprise methods, systems, and a computer readable medium comprising, but not limited to, at least one of the following:
A. A Company Creation Module 200;
B. A Job Lifecycle Module 300;
C. An API Module 400; and
D. A Token Generation Module 500.

Details with regard to each module are provided below. Although modules are disclosed with specific functionality, it should be understood that functionality may be shared between modules, with some functions split between modules, while other functions duplicated by the modules. Furthermore, the name of the module should not be construed as limiting upon the functionality of the module. Moreover, each component disclosed within each module can be considered independently without the context of the other components within the same module or different modules. Each component may contain language defined in other portions of this specifications. Each component disclosed for one module may be mixed with the functionality of another module. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of operations disclosed with reference to each module. For example, although methods may be described to be performed by a single computing device, it should be understood that, in some embodiments, different operations may be performed by different networked elements in operative communication with the computing device. For example, at least one computing device 900 may be employed in the performance of some or all of the stages disclosed with regard to the methods. Similarly, an apparatus may be employed in the performance of some or all of the stages of the methods. As such, the apparatus may comprise at least those architectural components as found in computing device 900.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed without altering or deterring from the fundamental scope of the depicted methods and systems disclosed herein.

Consistent with embodiments of the present disclosure, a method may be performed by at least one of the modules disclosed herein. The method may be embodied as, for example, but not limited to, computer instructions, which when executed, perform the method. The method may comprise the following stages:
generating a plurality of smart contracts corresponding to a hierarchical structure, each of the plurality of smart contracts being configured for on-chain association between one or more of the following:
   a business parent,
   a business subsidiary,
   a business,
   a business division,
   a business department,
   a business team, and
   a business project, for each of the plurality of smart contracts, defining the following:
   one or more triggering events for deployment via a blockchain protocol, and
   one or more parameters for minting one or more Soul Bound Tokens (“SBTs”), each of the one or more SBTs being associated with one of the following:
      a job hiring,
      a review, and
      another business project;
receiving an indication that the one or more triggering events have occurred;
identifying a recipient blockchain address associated with the one or more triggering events; and
deploying one or more of the plurality of smart contracts onto the recipient blockchain address associated with a user having performed the one or more triggering events.

Although the aforementioned method has been described to be performed by the platform 100, it should be understood that computing device 900 may be used to perform the various stages of the method. Furthermore, in some embodiments, different operations may be performed by different networked elements in operative communication with computing device 900. For example, a plurality of computing devices may be employed in the performance of some or all of the stages in the aforementioned method. Moreover, a plurality of computing devices may be configured much like a single computing device 900. Similarly, an apparatus may be employed in the performance of some or all stages in the method. The apparatus may also be configured much like computing device 900.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. PLATFORM CONFIGURATION

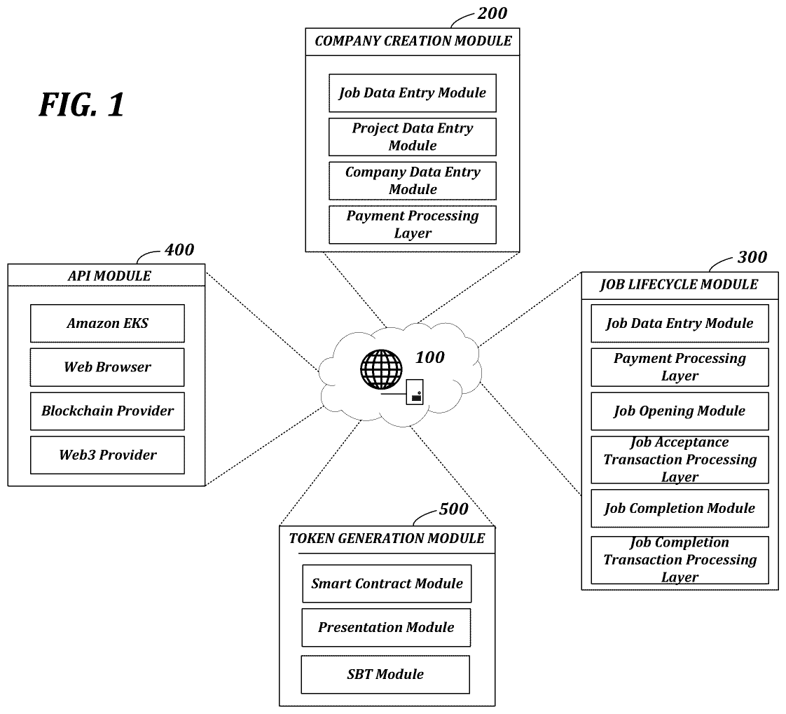

FIG. 1 illustrates one possible operating environment through which a platform consistent with embodiments of the present disclosure may be provided. By way of non-limiting example, a platform 100 for providing the methods and systems for may be hosted in both a blockchain protocol (“on-chain”) and off of a blockchain protocol (“off-chain”). One possible embodiment of the platform may be provided by the Seekr™ and/or Soul Bound Token (“SBT”) protocol provided by Seekr, LLC. It should be understood that layers and stages performed by the layers may be either “on-chain” or “off-chain.” The present disclosure anticipates embodiments with variations as to which stages may be performed “on-chain” or “off-chain.”

Accordingly, embodiments of the present disclosure provide a software and hardware platform comprised of a distributed set of computing elements, including, but not limited to:

### A. Company Creation Module 200

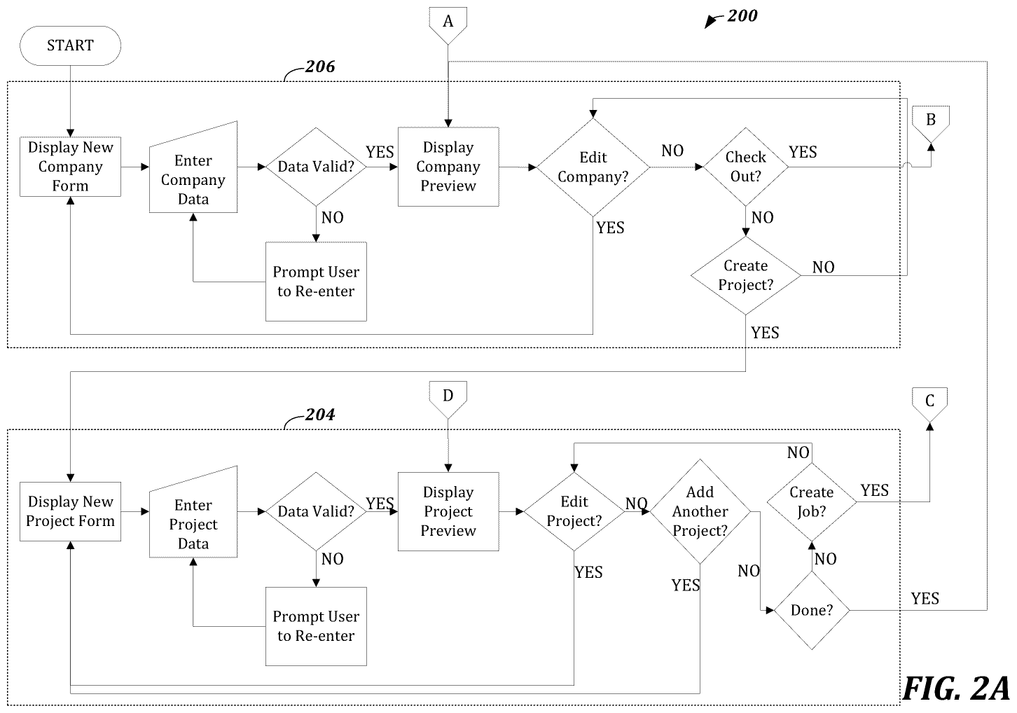

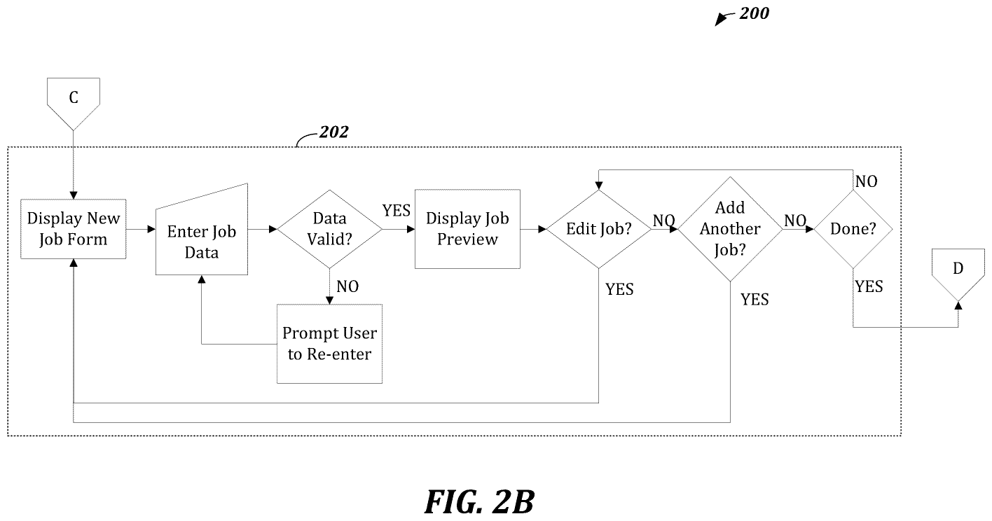

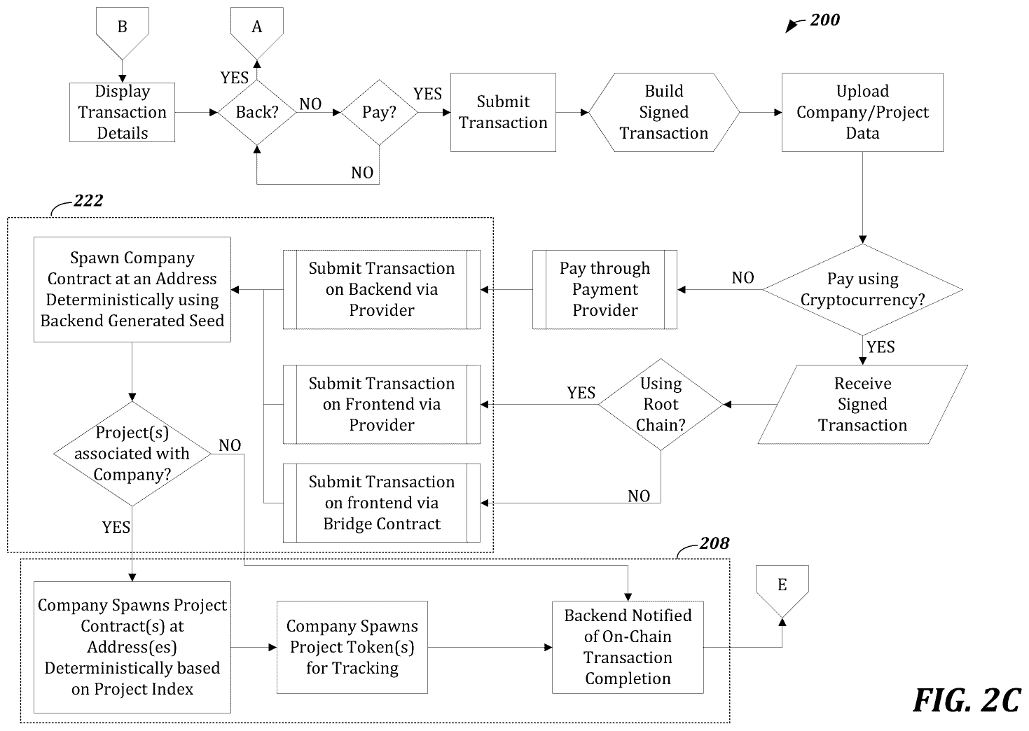

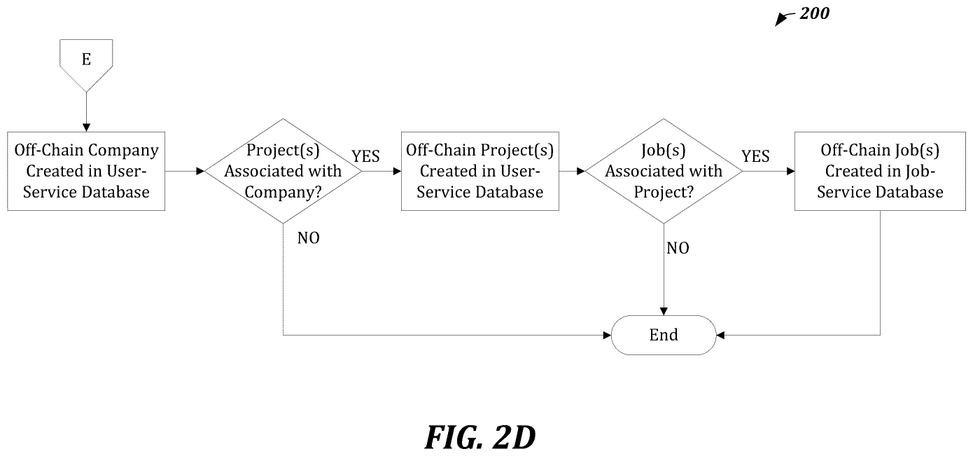

At least FIGS. 1 and 2A-2D illustrate a company creation module 200 consistent with embodiments of the present disclosure.

The company creation module 200 may comprise a job data entry module 202 consistent with the present disclosure. The job data entry module 202 may include hardware and/or software configured to populate a job description, create a job profile, and/or create a job request required for a particular project and for creation of one or more tokens related to the job. The job data entry module 202 may be displayed and/or interacted with via a User Interface (“UI”). In some embodiments, the job data entry module 202 may be configured to display a new job form. Responsive to a user inputting job data via the UI, the job data entry module 202 may perform a review of the inputted data. If the inputted data review determines the inputted data is not valid, the job data entry module 202 may return the user to the new job form. For example, the invalid data may be highlighted for correction by a user, or the user may be requested to re-enter the job data.

Alternatively, If the inputted data review determines the inputted data is valid, the job data entry module 202 may advance the user to a job preview display. The job preview display may aggregate, organize, and/or visualize at least a portion of the inputted job data. Based on the job preview display, the user may opt to edit the job. A command to edit the job may return the user to the new job form for editing.

If the user is satisfied with the job preview display, the user may be prompted to indicate whether to add another job. If the user chooses to add another job, the user may be returned to the new job form. If the user chooses not to add another job, the user may be advanced to a project preview display of a project data entry module 204.

The company creation module 200 may further comprise the project data entry module 204 consistent with the present disclosure. The project data entry module 204 may include hardware and/or software configured to populate a project description, create a project profile, and/or create a project request required for a particular company, and for creation of one or more tokens related to the project. The project data entry module 204 may be displayed and/or interacted with via the UI. In some embodiments, the project data entry module 204 may be configured to display a new project form. Responsive to a user inputting project data via the UI, the project data entry module 204 may perform a review of the inputted data. If the inputted data review determines the inputted data is not valid, the project data entry module 204 may return the user to the new project form. If the inputted data review determines the inputted data is valid, the project data entry module 204 may advance the user to a project preview display.

In the project preview display of the project data entry module 204, one or more jobs created from the job data entry module 202 may be imported by and/or used in the project preview display. The project preview display may aggregate, organize, and/or visualize at least a portion of the inputted project data and/or job data related to the project. Based on the project preview display, the user may opt to edit the project. In this case, the user is returned to the new project form for further editing. If the user is satisfied with the project preview display, the user may be prompted whether to add another project. If the user chooses to add another project, the user may be returned to the new project form.

If the user chooses not to add another project, the user may be prompted to decide whether to create a new job. If the user chooses to add another job, the user may be returned to the new job form in the job data entry module 202. If the user chooses not to add another job, the user may be advanced to a company preview display of a company data entry module 206.

The company creation module 200 may comprise the company data entry module 206 consistent with the present disclosure. The company data entry module 206 may include hardware and/or software configured to populate a company description, create a company profile, and/or create a company request required for a particular company, and for creation of one or more tokens related to the company. The company data entry module 206 may be displayed and/or interacted with via the UI. In some embodiments, the company data entry module 206 may be configured to display a new company form. Responsive to a user inputting company data via the UI, the company data entry module 206 may perform a review of the inputted data. If the inputted data review determines the inputted data is not valid, the company data entry module 206 may return the user to the new company form. If the inputted data review determines the inputted data is valid, the company data entry module 206 may advance the user to a company preview display.

In the company preview display, one or more projects created from the project data entry module 204 may be imported and/or used. The company preview display may aggregate, organize, and/or visualize at least a portion of the inputted company data and/or project data related to the company. Based on the company preview display, the user may opt to edit the company. In this case, the user is returned to the new company form for further editing. If the user is satisfied with the company preview display, the user may be prompted whether to add another company. If the user chooses to add another company, the user may be returned to the new company form. If the user chooses not to add another company, the user may be prompted to decide whether to create a new project. If the user chooses to add another project, the user may be returned to the new project form in the project data entry module 204. If the user chooses not to add another project, the user may be presented an option of whether to continue editing the company or not. Responsive to the user choosing not to further edit the company, the user may be returned to the displayed new company form. Responsive to the user choosing not to further edit the company, the user may be advanced to a checkout and display comprising a plurality of transaction details related to the company.

A payment processing layer may be provided responsive to completion of the company. The payment processing layer may comprise a payment protocol for the formation of the company. Responsive to receiving approval (e.g., signing) of the user, the company creation module 200 may build one or more backend processes related to the company. Responsive to receiving approval of the user, the company creation module 200 may upload various visual data related to the company (e.g., logos, names, trademarks, phrases, photos, etc.) to a storage and/or database (e.g., an Interplanetary File System [“IPFS”], any suitable distributed file system, and/or any suitable centralized file system).

The payment processing layer 222 may determine whether the user is paying with a decentralized and/or blockchain-based currency (e.g., native tokens and/or ERC20 tokens on an Ethereum Virtual Machine [“EVM”] compatible network, such as, but not limited to, MATIC, Ethereum, and/or USD Coin [“USDC”]). If the user is not paying via blockchain-based currency, the transaction may be submitted via a payment provider (e.g., any standard payment processor) which may in turn be submitted in the backend of the payment processing layer 222. For example, the payment may be submitted via a blockchain protocol. If the user is paying via blockchain-based currency and is using the root blockchain protocol, the transaction may be submitted via the front end of the payment processing layer via the root blockchain protocol. If the user is paying via blockchain-based currency but is not using a currency supported by the root blockchain protocol, the transaction may be submitted via the front end of the payment processing layer via a compatible bridge protocol. Whichever means of payment proffered by the user, the payment processing layer may advance the payment information, confirmation, and/or data related to the company to an on-chain creation module 208.

The company workflow module 200 may comprise the on-chain creation module 208 consistent with the present disclosure. The on-chain creation module 208 may include hardware and/or software configured to generate a company contract in response to completion of payment requirements. The company contract may be generated via a blockchain address using, for example, a backend generated seed. Responsive to the generation of the company contract, the on-chain creation module 208 may determine whether the company contract has one or more projects associated therewith. If the company does not have any projects, the backend is notified of a transaction completion.

If the company does have one or more projects associated therewith, a project contract may be created for each project associated with the company. In embodiments, the project contracts may be at addresses selected deterministically based on a project index. Responsive to the project contracts being created, one or more tokens may be generated for each project. The one or more tokens may be used for tracking purposes. By way of nonlimiting example, the one or more tokens may correspond to any token described in the present disclosure.

Responsive to an indication of an on-chain transaction being completed, an off-chain company may be created. The off-chain company may be created in a User-Service database. Responsive to the off-chain company being created, a determination may be made of whether the off-chain company has one or more projects associated therewith.

Responsive to the off-chain company not having projects, the process may terminate. Responsive to the off-chain company having projects, an off-chain project may be created in the User-Service database for each project associated with the company. Responsive to an off-chain project being created in the User-Service database, a determination may be made of whether each of the projects has one or more jobs associated therewith. If a project does not have any jobs, the process may terminate. If a project does have jobs, an off-chain job may be created in a Job-Service database for each job associated with the project.

### B. Job Lifecycle Module 300

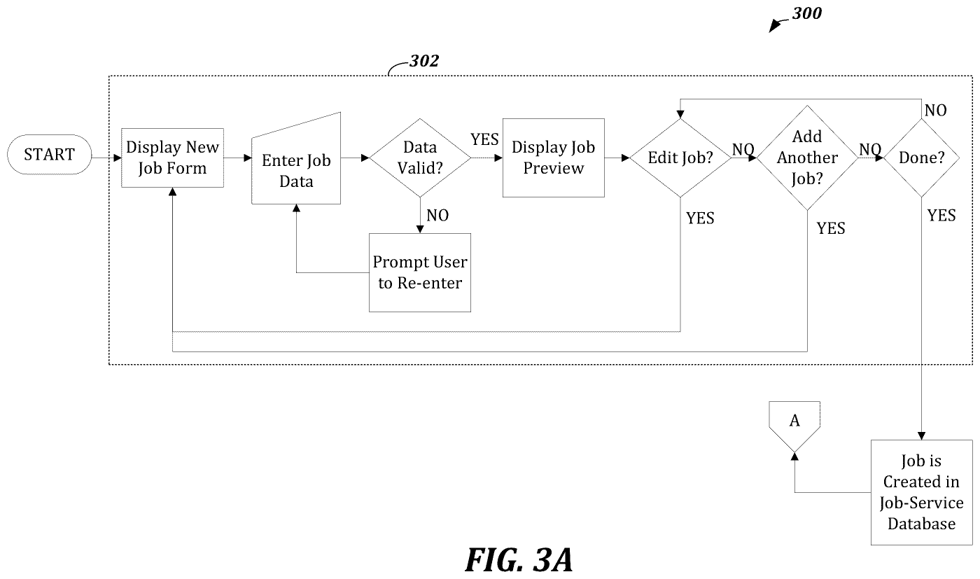

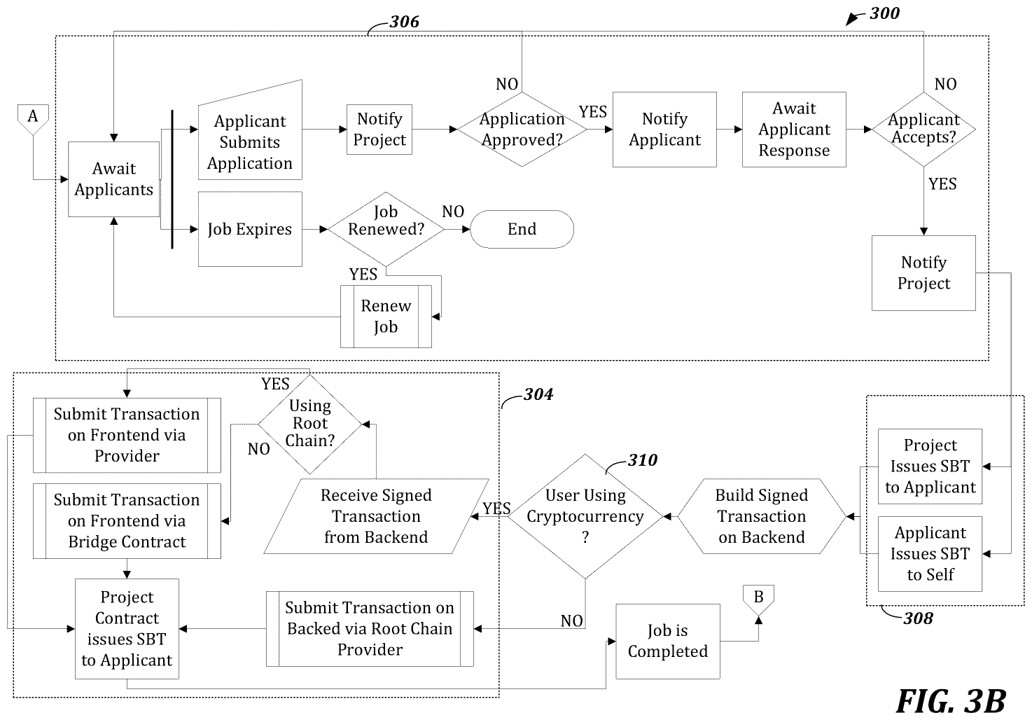

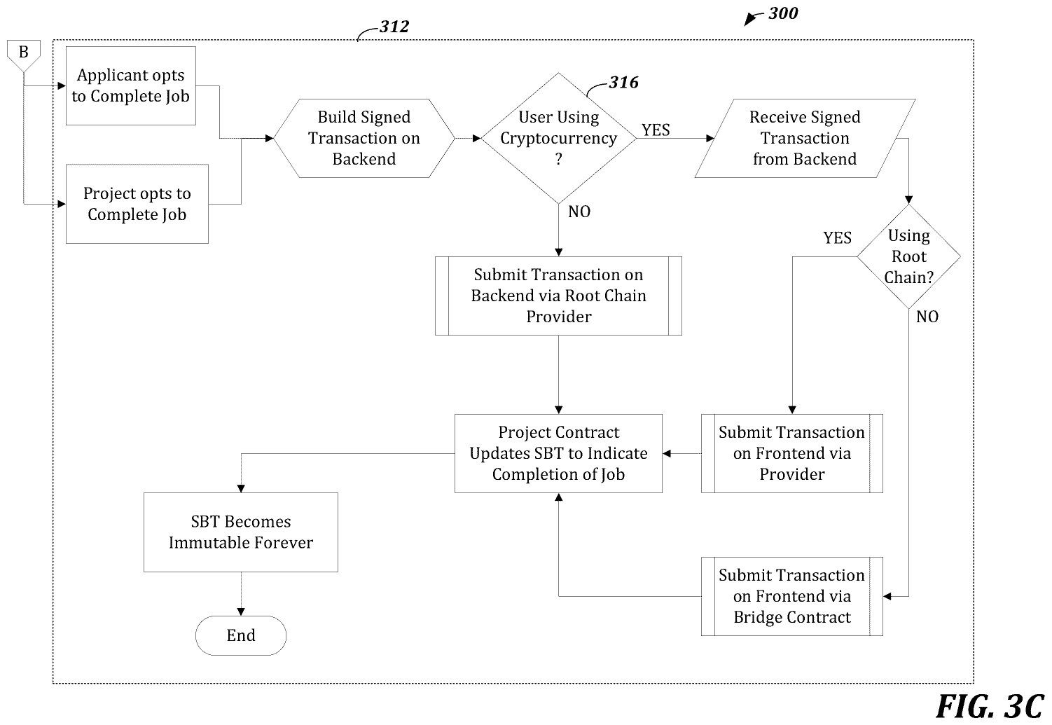

At least FIGS. 1 and 3A-3C illustrate the Job Lifecycle module 300 consistent with embodiments of the present disclosure.

The job lifecycle module 300 may include hardware and/or software configured to create one or more jobs and/or one or more job requests via a job data entry module 302. In one embodiment, the creation of one or more jobs may be similar to the job data entry module 202 consistent with the present disclosure. The job data entry module 302 may include hardware and/or software configured to populate a job description, create a job profile, and/or create a job request required for a particular project, and for creation of one or more tokens related to the job. The job data entry module 302 may be displayed and/or interacted with via the UI.

In some embodiments, the job data entry module 302 may be configured to display a new job form. Responsive to a user inputting job data via the UI, the job data entry module 202 may review the inputted data. If the inputted data review determines the inputted data is not valid, the job data entry module 302 may return the user to the new job form. If the inputted data review determines the inputted data is valid, the job data entry module 302 may advance the user to a job preview display. The job preview display may aggregate, organize, and/or visualize at least a portion of the inputted job data. Based on the job preview display, the user may opt to edit the job. In this case, the user is returned to the new job form for editing. If the user is satisfied with the job as shown in the job preview display, the user may be prompted whether to add another job. If the user chooses to add another job, the user may be returned to the new job form. If the user chooses not to add another job, the user may be advanced to the payment processing layer 304.

The payment processing layer 304 may be provided (e.g., accessed by the user, presented to the user) responsive to completion of the job creation request by the job data entry module 302. In one embodiment, the payment processing layer 304 may have similar attributes and/or processes as the payment processing layer 222. The payment processing layer 304 may comprise hardware and/or software supporting a payment protocol for the formation of the one or more jobs. Responsive to receiving approval (e.g., signing) of the user, the job data entry module 302 may proceed with building backend processes related to the job.

The payment processing layer 304 may further determine whether the user is paying with a decentralized and/or blockchain-based currency (e.g., Polygon™ network tokens and/or bitcoin). If the user is not paying via blockchain-based currency, the transaction may be submitted via a payment provider (e.g., any standard payment processor). If the user is paying via blockchain-based currency and is using a blockchain protocol, the transaction may be submitted via the front end of the payment processing layer via a blockchain protocol. If the user is paying via blockchain-based currency but is not using a currency supported by the platform's root blockchain's protocol, the transaction may be submitted via the front end of the payment processing layer via a compatible bridge protocol. Whichever the means of payment, responsive to a successful payment transaction (should one be required), the job may be created in the Job-Service database, posted and opened for applicants to apply to, and/or the payment processing layer 304 may pass an indication of payment to a job opening module 306.

In some embodiments, the job lifecycle module 300 may comprise a job opening module 306. The job opening module may include hardware and/or software configured to process job applications associated with one or more job openings. For each of the one or more jobs (and/or “job openings”) an employee, manager, user, and/or participant of a project requiring the one or more jobs may receive one or more application submissions for the one or more jobs. Each application may be associated with an applicant. When the user rejects the application, no further action is taken. When the user accepts the application, the applicant associated with the application is notified with an offer. If the applicant rejects the offer, the user is notified, and no further action is taken. If the applicant accepts the offer, the user is notified and the applicant's information is passed to a job acceptance module 308.

In some embodiments, the job lifecycle module 300 may comprise a job acceptance module 308 for actions and processes related to job acceptance. The job acceptance module 308 may include hardware and/or software used to facilitate data flow, information processing, and token generating related to newly hired applicant for one or more jobs. In some embodiments, the job lifecycle module 300 may be configured to facilitate generation and/or initiate issuance of a token (e.g., a Soul Bound Token (“SBT”)) from the project to the applicant and/or from the applicant to the project. Responsive to the SBT being generated, a signed transaction (and/or smart contract) may be built for receipt of the SBT. Responsive to the signed transaction being built, the user (and/or the applicant) may then be directed to a job acceptance transaction processing layer 310.

The job acceptance transaction processing layer 310 may further determine whether the user is paying with a decentralized and/or blockchain-based currency (e.g., Polygon™ network tokens and/or bitcoin). If the user is not paying via blockchain-based currency, the transaction may be submitted in the backend of the job acceptance transaction processing layer 310 via the root blockchain protocol. If the user is using blockchain-based currency and is using the root blockchain protocol, the transaction may be submitted via the front end of the transaction processing layer 310 via the root blockchain protocol. If the user is using a blockchain-based currency but is not using a currency supported by the root blockchain protocol, the transaction may be submitted via the front end of the job acceptance transaction processing layer 310 via a compatible bridge protocol. Whichever the means of transaction, responsive to a completed transaction, the user and/or project may be configured to issue the one or more tokens to the applicant.

In some embodiments, the job lifecycle module 300 may include a job completion module 312 for actions and processes related to completion of the job. In some embodiments, the applicant may complete their corresponding job. In other embodiments, the user and/or project may determine completion of the applicant's corresponding job. Responsive to the completion of the job, the user (and/or the applicant) may then be directed a transaction processing layer 316.

The job completion transaction processing layer 316 may further determine whether the user is paying with a decentralized and/or blockchain-based currency (e.g., Polygon™ network tokens and/or bitcoin). If the user is not paying via blockchain-based currency, the transaction may be submitted in the backend of the job completion transaction processing layer 316 via one of a plurality of blockchain provider protocols. If the user is using blockchain-based currency and is using the root blockchain protocol, the transaction may be submitted via the front end of the job completion transaction processing layer 316 via the root blockchain protocol. If the user is using a blockchain-based currency but is not using a currency supported by the root blockchain protocol, the transaction may be submitted via the front end of the job completion transaction processing layer 316 via a compatible bridge protocol. Whichever the means of transaction, responsive to a completed transaction, the SBT issued to the applicant may be updated to indicate completion of the job. After the update, the SBT may become immutable.

### C. API Module 400

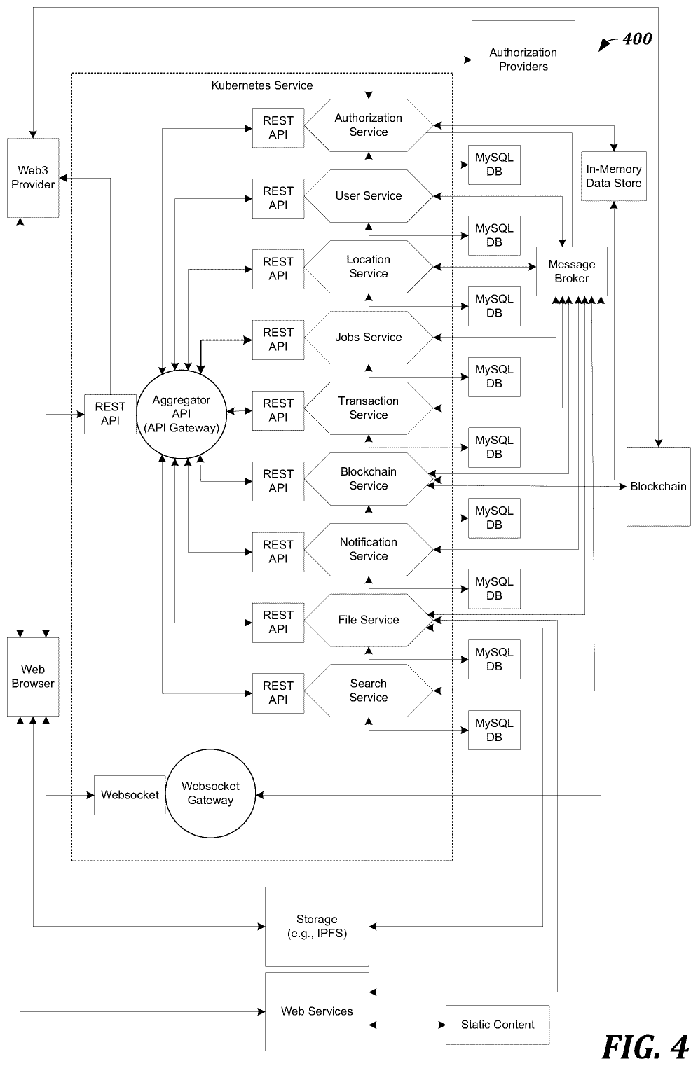

At least FIGS. 1 and 4 illustrate the API module 400 consistent with an embodiment of the present disclosure.

In the API module 400, hardware and/or software (e.g., a web browser, GUI, and/or UI) may be utilized by a user to facilitate accessible static content via JavaScript, HTML, CSS, and related web browser languages.

The web browser may also facilitate accessibility to a Web3 provider. The Web3 provider may be associated with one or more blockchain providers and/or protocols. The one or more blockchain providers and/or protocols may be in communication with (e.g., via a JSON RPC protocol) a blockchain service hosted on and/or residing in, as a non-limiting example, a Kubernetes Service such as an Amazon™ Elastic Kubernetes Service (“EKS”). The Amazon™ EKS may provide, host, and/or store (as non-limiting examples) one or more of the following (with or without a corresponding REST API):
a. an authorization service,
b. a user service,
c. a jobs service,
d. a transaction service,
e. a notification service,
f. a file service,
g. a WebSocket gateway,
h. and an aggregator API,
i. a location service, and/or
j. a search service.

### D. Token Generation Module 500

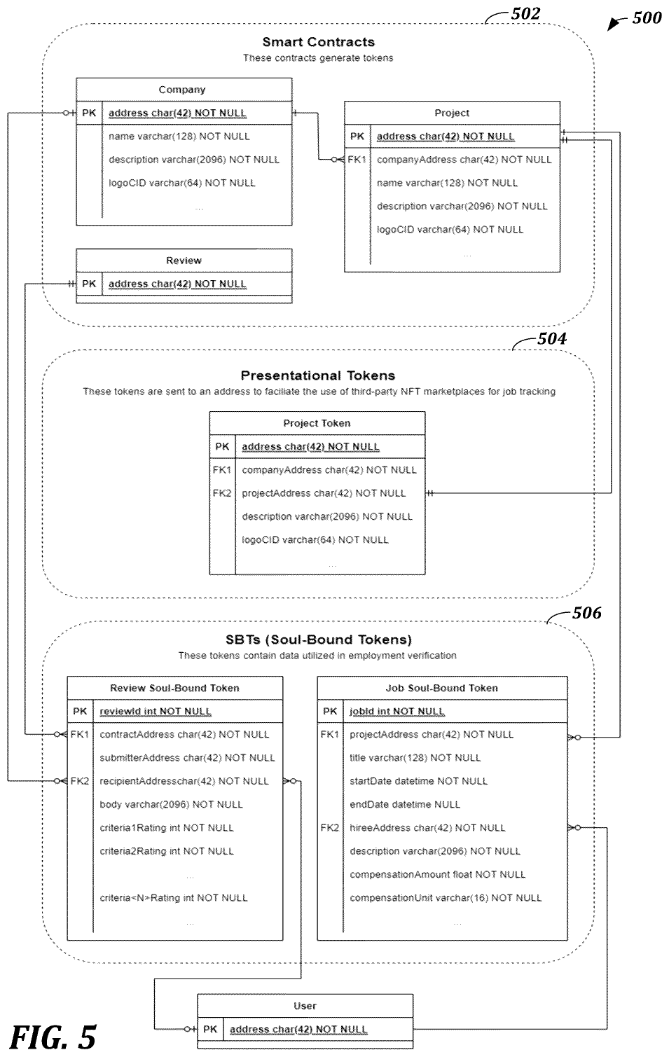

At least FIGS. 1 and 5 illustrate the token generation module 500 consistent with an embodiment of the present disclosure. In some embodiments, the token generation module 500 may comprise a smart contract module 502. The smart contract module 502 may include hardware and/or software used to generate one or more tokens. In some embodiments, the smart contract module 502 may comprise a company having a company blockchain address, a name, a company description, and/or a company logo. In further embodiments, the smart contract module 502 may comprise one or more projects associated with, and/or managed by, the company. Each of the one or more projects may comprise a project blockchain address, an association with the company blockchain address, a project name, a project description, and/or a project logo.

In some embodiments, the token generation module 500 may comprise a project token module 504. The project token module 504 may comprise one or more project tokens generated from each of the one or more projects. Each of the one or more project tokens may comprise the corresponding company blockchain address, the corresponding project blockchain address, the project description, and/or the project logo. Each project token may be configured as a presentational token, and/or may be configured to allow viewing access and/or observational privileges to a soulbound token associated with the project token.

In some embodiments, the token generation module 500 may comprise an SBT module 506. The SBT module 506 may comprise a review SBT. The review SBT may be associated with information such as (but not limited to) a smart contract blockchain address, a submitter blockchain address, a recipient blockchain address, and/or one or more criterion related to the employment contract. The SBT module 506 may further comprise a job SBT. The job SBT may be associated with information such as (but not limited to) a project blockchain address, a start date, an end date, a hiree blockchain address, a job description, a job compensation amount, and/or a compensation unit.

### III. PLATFORM OPERATION

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described to be performed by a single computing device, it should be understood that, in some embodiments, different operations may be performed by different networked elements in operative communication with the computing device. For example, at least one computing device 900 may be employed in the performance of some or all of the stages disclosed with regard to the methods. Similarly, an apparatus may be employed in the performance of some or all of the stages of the methods. As such, the apparatus may comprise at least those architectural components as found in computing device 900.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

A. Method 1000 for Integrating Hierarchically Linked Smart Contracts with Tokenized Verification

Consistent with embodiments of the present disclosure, a method 1000 may be performed by at least one of the aforementioned modules. The method 1000 may be embodied as, for example, but not limited to, computer instructions, which when executed, perform the method. The method may comprise the following stages:
a 1005—generating a plurality of smart contracts corresponding to a hierarchical structure;
b. 1010—for each of the of the plurality of smart contracts, defining the following: one or more triggering events for deployment via a blockchain protocol, and one or more parameters for minting one or more Soul Bound Tokens (“SBTs”);
c. 1015—receiving an indication that the or more triggering events have occurred;
d. 1020—identifying a blockchain address associated with the one or more triggering events;
e. 1025—deploying one or more of the plurality of smart contracts onto the recipient blockchain address associated with a user having performed the one or more triggering events;
f. (Optional) 1030—generating a presentational token; and
g. (Optional) 1035—defining an off-chain controller operatively connected to the hierarchical smart contract.

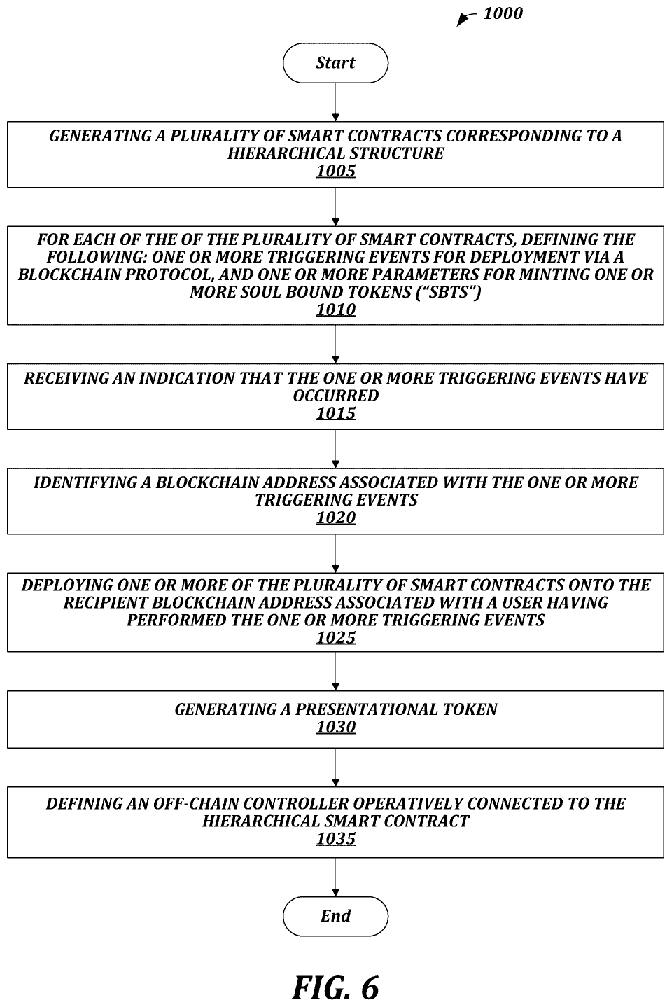

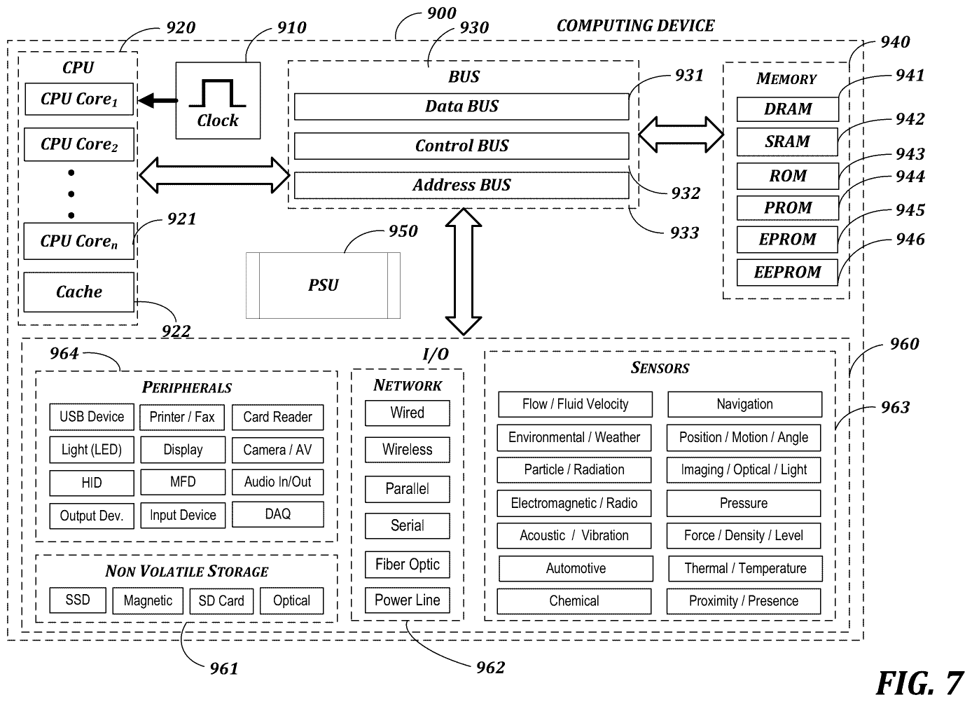

FIG. 6 is a flow chart setting forth the general stages involved in a method 1000 consistent with an embodiment of the disclosure. Method 1000 may be implemented using a computing device 900 or any other component associated with platform 100 as described in more detail below with respect to FIG. 7. For illustrative purposes alone, computing device 900 is described as one potential actor in the follow stages.

Method 1000 may begin stage 1005 where computing device 900 may generate a plurality of smart contracts corresponding to a hierarchical structure. Each of the plurality of smart contracts may correspond to a hierarchical structure of one or more of the following:
a. a business parent,
b. a business subsidiary,
c. a business,
d. a business division,
e. a business department,
f. a business team, and
g. a business project.

By way of nonlimiting example, the hierarchical structure may correspond to at least a portion of a corporate structure of a company.

From stage 1005, where computing device 900 generates the plurality of smart contracts corresponding to a hierarchical structure, method 1000 may advance to stage 1010 where computing device 900 may, for each of the plurality of smart contracts, define the following: one or more triggering events for deployment via a blockchain protocol, and one or more parameters for minting one or more SBTs. The triggering event may comprise completion of one or more predetermined requirements for deployment of the smart contract. By way of nonlimiting example, the triggering event for deployment of the one or more SBTs may comprise a job hiring, a review, and/or another business project.

Once computing device 900, for each of the plurality of smart contracts, defines the one or more triggering events for deployment of the SBTs via a blockchain protocol and the one or more parameters for minting the one or more SBTs in stage 1010, method 1000 may continue to stage 1015 where computing device 900 may receive an indication that the one or more triggering events has occurred.

After computing device 900 receives an indication that the one or more triggering events have occurred in stage 1015, method 1000 may proceed to stage 1020 where computing device 900 may identify a recipient blockchain address associated with (and/or responsible for) the one or more triggering events. The blockchain address may be embodied as, for example, a blockchain wallet. In some embodiments, the blockchain address associated with the one or more triggering events may be an employee completing a project, the employee being associated with a blockchain address.

After computing device 900 identifies the blockchain address associated with the one or more triggering events in stage 1020, method 1000 may end at stage 1025 where computing device 900 may deploy one or more of the plurality of smart contracts onto the recipient blockchain address associated with a user having performed the one or more triggering events. In another embodiment, the method may proceed by minting a token onto responsive to the one or more parameters occurring. In some embodiments, at least a portion of the token is immutable responsive to the token being minted. In other embodiments, another predetermined portion of the token is mutable responsive to the token being minted. In further embodiments, the token, responsive to being minted, is permanently associated with the blockchain address.

Optionally, computing device 900 may perform stage 1030, minting a presentational token. The presentational token may be minted responsive to an indication that a business project, generated via a company contract, is not ERC721 compatible. In some embodiments, the presentational token is utilized as a visual representation minted in parallel with the business project. The presentational token may be configured to allow viewing access and/or observational privileges to the business project associated with the blockchain address. In some embodiments, the presentational token may comprise at least a portion of metadata related to its corresponding business project. The presentational token may be viewable via Non-Fungible Token (“NFT”) viewing protocols.

Optionally, computing device 900 may perform stage 1035, defining an off-chain controller operatively connected to the hierarchical smart contract. In some embodiments, the off-chain controller may be configured to receive off-chain commands. In further embodiments, the off-chain controller may be configured to modify, control, and/or manage at least a portion of the hierarchical smart contract based on the off-chain commands. In further embodiments, the off-chain controller may comprise an integration parameter for the hierarchical smart contract.

### IV. COMPUTING DEVICE ARCHITECTURE

Embodiments of the present disclosure provide a hardware and software platform operative as a distributed system of modules and computing elements.

Platform 100 may be embodied as, for example, but not be limited to, a website, a web application, a desktop application, backend application, and a mobile application compatible with a computing device 900. The computing device 900 may comprise, but not be limited to the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exa-scale supercomputer, a mainframe, or a quantum computer;
A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack mounted, a workstation, an industrial device, a raspberry pi, a desktop, or an embedded device;
Platform 100 may be hosted on a centralized server or a cloud computing service. Although method 1000 has been described to be performed by a computing device 900, it should be understood that, in some embodiments, different operations may be performed by a plurality of the computing devices 900 in operative communication at least one network.

Embodiments of the present disclosure may comprise a system having a central processing unit (CPU) 920, a bus 930, a memory unit 940, a power supply unit (PSU) 950, and one or more Input/Output (I/O) units. The CPU 920 coupled to the memory unit 940 and the plurality of I/O units 960 via the bus 930, all of which are powered by the PSU 950. It should be understood that, in some embodiments, each disclosed unit may actually be a plurality of such units for the purposes of redundancy, high availability, and/or performance. The combination of the presently disclosed units is configured to perform the stages any method disclosed herein.

FIG. 7 is a block diagram of a system including computing device 900. Consistent with an embodiment of the disclosure, the aforementioned CPU 920, the bus 930, the memory unit 940, a PSU 950, and the plurality of I/O units 960 may be implemented in a computing device, such as computing device 900 of FIG. 7. Any suitable combination of hardware, software, or firmware may be used to implement the aforementioned units. For example, the CPU 920, the bus 930, and the memory unit 940 may be implemented with computing device 900 or any other computing devices 900, in combination with computing device 900. The aforementioned system, device, and components are examples and other systems, devices, and components may comprise the aforementioned CPU 920, the bus 930, the memory unit 940, consistent with embodiments of the disclosure.

At least one computing device 900 may be embodied as any of the computing elements illustrated in all of the attached figures, including the method 1000, company creation module 200, the job lifecycle module 300, the API module 400, and the token generation module 500. A computing device 900 does not need to be electronic, nor even have a CPU 920, nor bus 930, nor memory unit 940. The definition of the computing device 900 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 900, especially if the processing is purposeful.

With reference to FIG. 7, a system consistent with an embodiment of the disclosure may include a computing device, such as computing device 900. In a basic configuration, computing device 900 may include at least one clock module 910, at least one CPU 920, at least one bus 930, and at least one memory unit 940, at least one PSU 950, and at least one I/O 960 module, wherein I/O module may be comprised of, but not limited to a non-volatile storage sub-module 961, a communication sub-module 962, a sensors sub-module 963, and a peripherals sub-module 964.

A system consistent with an embodiment of the disclosure the computing device 900 may include the clock module 910 may be known to a person having ordinary skill in the art as a clock generator, which produces clock signals. A clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 920, the central component of modern computers, which relies on a clock. The only exceptions are asynchronous circuits such as asynchronous CPUs. The clock 910 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 900 use a “clock multiplier” which multiplies a lower frequency external clock to the appropriate clock rate of the CPU 920. This allows the CPU 920 to operate at a much higher frequency than the rest of the computer, which affords performance gains in situations where the CPU 920 does not need to wait on an external factor (like memory 940 or input/output 960). Some embodiments of the clock 910 may include dynamic frequency change, where, the time between clock edges can vary widely from one edge to the next and back again.

A system consistent with an embodiment of the disclosure the computing device 900 may include the CPU unit 920 comprising at least one CPU Core 921. A plurality of CPU cores 921 may comprise identical CPU cores 921, such as, but not limited to, homogeneous multi-core systems. It is also possible for the plurality of CPU cores 921 to comprise different CPU cores 921, such as, but not limited to, heterogeneous multi-core systems, big.LITTLE systems and some AMD accelerated processing units (APU). The CPU unit 920 reads and executes program instructions which may be used across many application domains, for example, but not limited to, general purpose computing, embedded computing, network computing, digital signal processing (DSP), and graphics processing (GPU). The CPU unit 920 may run multiple instructions on separate CPU cores 921 at the same time. The CPU unit 920 may be integrated into at least one of a single integrated circuit die and multiple dies in a single chip package. The single integrated circuit die and multiple dies in a single chip package may contain a plurality of other aspects of the computing device 900, for example, but not limited to, the clock 910, the CPU 920, the bus 930, the memory 940, and I/O 960.

The CPU unit 920 may contain cache 922 such as, but not limited to, a level 1 cache, level 2 cache, level 3 cache or combination thereof. The aforementioned cache 922 may or may not be shared amongst a plurality of CPU cores 921. The cache 922 sharing comprises at least one of message passing and inter-core communication methods may be used for the at least one CPU Core 921 to communicate with the cache 922. The inter-core communication methods may comprise, but not limited to, bus, ring, two-dimensional mesh, and crossbar. The aforementioned CPU unit 920 may employ symmetric multiprocessing (SMP) design.

The plurality of the aforementioned CPU cores 921 may comprise soft microprocessor cores on a single field programmable gate array (FPGA), such as semiconductor intellectual property cores (IP Core). The plurality of CPU cores 921 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 921, for example, but not limited to Instruction-level parallelism (ILP) such as, but not limited to, superscalar pipelining, and Thread-level parallelism (TLP).

Consistent with the embodiments of the present disclosure, the aforementioned computing device 900 may employ a communication system that transfers data between components inside the aforementioned computing device 900, and/or the plurality of computing devices 900. The aforementioned communication system will be known to a person having ordinary skill in the art as a bus 930. The bus 930 may embody internal and/or external plurality of hardware and software components, for example, but not limited to a wire, optical fiber, communication protocols, and any physical arrangement that provides the same logical function as a parallel electrical bus. The bus 930 may comprise at least one of, but not limited to, a parallel bus, wherein the parallel bus carry data words in parallel on multiple wires, and a serial bus, wherein the serial bus carry data in bit-serial form. The bus 930 may embody a plurality of topologies, for example, but not limited to, a multidrop/electrical parallel topology, a daisy chain topology, and a connected by switched hubs, such as USB bus. The bus 930 may comprise a plurality of embodiments, for example, but not limited to:
Internal data bus (data bus) 931/Memory bus
Control bus 932
Address bus 933
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect extended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper {Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and extensible Host Controller Interface (xHCl).

Consistent with the embodiments of the present disclosure, the aforementioned computing device 900 may employ hardware integrated circuits that store information for immediate use in the computing device 900, know to the person having ordinary skill in the art as primary storage or memory 940. The memory 940 operates at high speed, distinguishing it from the non-volatile storage sub-module 961, which may be referred to as secondary or tertiary storage, which provides slow-to-access information but offers higher capacities at lower cost. The contents contained in memory 940 may be transferred to secondary storage via techniques such as, but not limited to, virtual memory and swap. The memory 940 may be associated with addressable semiconductor memory, such as integrated circuits consisting of silicon-based transistors, used for example as primary storage but also for other purposes in the computing device 900. The memory 940 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 941, Static Random-Access Memory (SRAM) 942, CPU Cache memory 922, Advanced Random-Access Memory (A-RAM), and other types of primary storage such as Random-Access Memory (RAM).
Non-volatile memory which can retain stored information even after power is removed, for example, but not limited to, Read-Only Memory (ROM) 943, Programmable ROM (PROM) 944, Erasable PROM (EPROM) 945, Electrically Erasable PROM (EEPROM) 946 (e.g., flash memory and Electrically Alterable PROM [EAPROM]), Mask ROM (MROM), One Time Programable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 900 may employ the communication system between an information processing system, such as the computing device 900, and the outside world, for example, but not limited to, human, environment, and another computing device 900. The aforementioned communication system will be known to a person having ordinary skill in the art as I/O 960. The I/O module 960 regulates a plurality of inputs and outputs with regard to the computing device 900, wherein the inputs are a plurality of signals and data received by the computing device 900, and the outputs are the plurality of signals and data sent from the computing device 900. The I/O module 960 interfaces a plurality of hardware, such as, but not limited to, non-volatile storage 961, communication devices 962, sensors 963, and peripherals 964. The plurality of hardware is used by the at least one of, but not limited to, human, environment, and another computing device 900 to communicate with the present computing device 900. The I/O module 960 may comprise a plurality of forms, for example, but not limited to channel I/O, port mapped I/O, asynchronous I/O, and Direct Memory Access (DMA).

Consistent with the embodiments of the present disclosure, the aforementioned computing device 900 may employ the non-volatile storage sub-module 961, which may be referred to by a person having ordinary skill in the art as one of secondary storage, external memory, tertiary storage, off-line storage, and auxiliary storage. The non-volatile storage sub-module 961 may not be accessed directly by the CPU 920 without using intermediate area in the memory 940. The non-volatile storage sub-module 961 does not lose data when power is removed and may be two orders of magnitude less costly than storage used in memory module, at the expense of speed and latency. The non-volatile storage sub-module 961 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (961) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD+RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 900 may employ the communication sub-module 962 as a subset of the I/O 960, which may be referred to by a person having ordinary skill in the art as at least one of, but not limited to, computer network, data network, and network. The network allows computing devices 900 to exchange data using connections, which may be known to a person having ordinary skill in the art as data links, between network nodes. The nodes comprise network computer devices 900 that originate, route, and terminate data. The nodes are identified by network addresses and can include a plurality of hosts consistent with the embodiments of a computing device 900. The aforementioned embodiments include, but are not limited to personal computers, phones, servers, drones, and networking devices such as, but not limited to, hubs, switches, routers, modems, and firewalls.

Two nodes can be said are networked together, when one computing device 900 is able to exchange information with the other computing device 900, whether or not they have a direct connection with each other. The communication sub-module 962 supports a plurality of applications and services, such as, but not limited to World Wide Web (WWW), digital video and audio, shared use of application and storage computing devices 900, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 962 may comprise a plurality of size, topology, traffic control mechanism and organizational intent. The communication sub-module 962 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 900 may employ the sensors sub-module 963 as a subset of the I/O 960. The sensors sub-module 963 comprises at least one of the devices, modules, and subsystems whose purpose is to detect events or changes in its environment and send the information to the computing device 900. Sensors are sensitive to the measured property, are not sensitive to any property not measured, but may be encountered in its application, and do not significantly influence the measured property. The sensors sub-module 963 may comprise a plurality of digital devices and analog devices, wherein if an analog device is used, an Analog to Digital (A-to-D) converter must be employed to interface the said device with the computing device 900. The sensors may be subject to a plurality of deviations that limit sensor accuracy. The sensors sub-module 963 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (02), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 900 may employ the peripherals sub-module 962 as a subset of the I/O 960. The peripheral sub-module 964 comprises ancillary devices used to put information into and get information out of the computing device 900. There are 3 categories of devices comprising the peripheral sub-module 964, which exist based on their relationship with the computing device 900, input devices, output devices, and input/output devices. Input devices send at least one of data and instructions to the computing device 900. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 900. Output devices convert electronically generated information into a form that can be presented to humans. Input/output devices that perform both input and output functions. It should be understood by a person having ordinary skill in the art that the ensuing are non-limiting embodiments of the aforementioned peripheral sub-module 964:
Input Devices
   Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, which require up to six degrees of freedom such as, but not limited to, camera gimbals, Cave Automatic Virtual Environment (CAVE), and virtual reality systems.
   Video Input devices are used to digitize images or video from the outside world into the computing device 900. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device, in order to capture produced sound. Audio input devices allow a user to send audio signals to the computing device 900 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data Acquisition (DAQ) devices convert at least one of analog signals and physical parameters to digital values for processing by the computing device 900. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers and plotters.
   Audio and Video (AV) devices, such as, but not limited to, speakers, headphones, amplifiers and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking devices (e.g., devices disclosed in network 962 sub-module), data storage device (non-volatile storage 961), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. ASPECTS

The following disclose various Aspects of the present disclosure. The various Aspects are not to be construed as patent claims unless the language of the Aspect appears as a patent claim. The Aspects describe various non-limiting embodiments of the present disclosure.
Aspect 1. A presentational token may be embodied as a token whose purpose is not requisite to the function of the system, but rather whose existence may serve to supplement a user experience via providing a more human-accessible structure to otherwise difficult-to-interpret data, often by mirroring or otherwise proxying the data contained within various opaque structures. One nonlimiting example may be embodied as presenting projects, which are otherwise ERC721 token contracts whose tokens may represent job SBTs, as a token inside the company contract, another ERC721 contract which relates companies directly to their child components (projects, subsidiaries, etc.). By doing so, various blockchain explorers and NFT marketplaces may interpret projects as tokens beneath a company “collection” possessed by the project contract address. The presentational tokens may provide a means for a user to easily click through popular interfaces in order to follow the hierarchy of a job SBT all the way to the originating company, or follow the path from a company down to any number of its job SBT.
Aspect 2. In nonlimiting reference to SBT ownership, any SBT minted may be subsequently tagged to an employee but is retained in the project blockchain wallet, which may be tied to the company blockchain wallet. In this embodiment, the SBT will always be a part of the project blockchain address, but the employee may be tagged as the holder of the SBT.
Aspect 3. A method for integrating hierarchically linked smart contracts with tokenized verification, the method comprising: generating a plurality of smart contracts corresponding to a hierarchical structure, each of the plurality of smart contracts being configured for on-chain association between one or more of the following: a business parent, a business subsidiary, a business, a business division, a business department, a business team, and a business project, for each of the plurality of smart contracts, defining the following: one or more triggering events for deployment via a blockchain protocol, and one or more parameters for minting one or more Soul Bound Tokens (“SBTs”), each of the one or more SBTs being associated with one of the following: a job hiring, a review, or another business project; responsive to receiving an indication that the one or more triggering events have occurred, identifying a recipient blockchain address associated with the one or more triggering events; and deploying one or more of the plurality of smart contracts onto the recipient blockchain address corresponding to a user associated with the one or more triggering events.
Aspect 4. The method of any previous Aspect, further comprising an off-chain controller operatively connected to at least a portion of the plurality of smart contracts, wherein the off-chain controller is configured to receive off-chain commands, and modify, control, and/or manage at least a portion of the plurality of smart contracts based on the off-chain commands.
Aspect 5. The method of any previous Aspect, wherein at least a portion of the SBT is immutable responsive to the token being deployed.
Aspect 6. The method of any previous Aspect, wherein a predetermined portion of the SBT is mutable responsive to the token being deployed.
Aspect 7. The method of any previous Aspect, wherein one or more of the following prompts an alteration of the mutable portion of the SBT: a job promotion, a project completion, a project termination, and a job termination.
Aspect 8. The method of any previous Aspect, wherein the SBT, responsive to being deployed, is permanently associated with the blockchain address.
Aspect 9. The method of any previous Aspect, further comprising, minting one or more presentational tokens, each of the one or more presentational tokens minted in parallel to a smart contract related to a business project.
Aspect 10. The method of any previous Aspect, wherein a termination of one job SBT and the production of another job SBT indicates a job promotion.
Aspect 11. The method of any previous Aspect, further comprising: receiving an indication that the one or more parameters have occurred, and minting the one or more SBTs.
Aspect 12. A blockchain-based employment verification system comprising: a plurality of self-identifying project-factory smart contracts configured to generate subsidiary-level token collection contracts; a token issuance module configured to issue Soul Bound Tokens (SBTs) that associate one or more employees with their respective job descriptions and job durations; a verification module configured to track information associated with employee affiliation and employee role for a company based at least in part on the issued SBTs; wherein the system is configured to accommodate one or more hierarchical structures for each company.
Aspect 13. The system of any previous Aspect, wherein at least one of the project-factory smart contracts are further configured to produce subsidiary-level token collection contracts for entities beneath a parent company, such that the subsidiary-level token collection contracts specify a subsidiary of the parent company for tracking employment while enabling proof of employment under the parent entity.
Aspect 14. The system of any previous Aspect, further comprising: an on-chain rating and review module configured to associate ratings and reviews with each entity within the system; an employment history aggregation module configured to compile a job seeker's employment history based on the associated ratings and reviews; a company reputation synopsis module configured to aggregate and display a company's reputation as an employer based on the ratings and reviews.
Aspect 15. The system of any previous Aspect, further comprising: a peer-to-peer employer-employee verification module configured to populate employment data onto the blockchain for employment tracked outside of the system.
Aspect 16. The system of any previous Aspect, wherein the token issuance module is further configured to issue SBTs that are immutable and non-transferable, thereby creating an on-blockchain resume for each employee.
Aspect 17. The system of any previous Aspect, wherein the verification module is further configured to: validate the authenticity of the SBTs and the employment data associated with each token; and allow one or more third parties to verify an employee work history without compromising employee privacy.
Aspect 18. The system of any previous Aspect, wherein the system is configured to operate on a public blockchain network, allowing for decentralized access and verification of employment data.
Aspect 19. The system of any previous Aspect, wherein the blockchain-based employment verification system is configured to utilize a distributed ledger technology for recording transactions and the issuance of Soul Bound Tokens (SBTs).
Aspect 20. The system of any previous Aspect, wherein the distributed ledger is a public blockchain that ensures immutability and transparency of the employment data recorded therein.
Aspect 21. The system of any previous Aspect, wherein the project-factory smart contracts are executed on the blockchain and are immutable once deployed, ensuring the integrity of the subsidiary-level token collection contracts generated therefrom.
Aspect 22. The system of any previous Aspect, wherein the token issuance module is further configured to record the issuance of SBTs on the blockchain, providing a tamper-evident record of each employee's affiliation and role for a company.
Aspect 23. The system of any previous Aspect, wherein the on-chain rating and review module is further configured to store ratings and reviews as transactions on the blockchain, allowing for the creation of a verifiable and permanent record of feedback.
Aspect 24. The system of any previous Aspect, wherein the verification module includes a smart contract-based verification process that utilizes blockchain consensus mechanisms to validate the authenticity of employment data.
Aspect 25. The system of any previous Aspect, wherein the peer-to-peer employer-employee verification workflow includes blockchain-based smart contracts to facilitate the verification and addition of external employment data to the blockchain.
Aspect 26. The system of any previous Aspect, wherein the manual intervention module includes a blockchain transaction override mechanism, allowing authorized personnel to correct or update employment data on the blockchain in the event of discrepancies.
Aspect 27. The system of any previous Aspect, wherein the system further includes a blockchain-based access control module that manages permissions for viewing and verifying the employment data recorded on the blockchain.
Aspect 28. The system of any previous Aspect, wherein the system is further configured to issue cryptographic tokens representing the SBTs, which are stored in a blockchain wallet associated with the respective employee.
Aspect 29. A method for verifying employment history using a blockchain-based system, comprising: receiving a request to verify an individual's employment history; accessing a distributed ledger to retrieve Soul Bound Tokens (SBTs) associated with the individual's employment; validating the authenticity of the SBTs using a consensus mechanism inherent to the blockchain; aggregating the validated employment data to generate a comprehensive employment history for the individual; and providing a verified employment history to the requestor, wherein the employment history is immutable and resistant to fraud due to the blockchain-based verification.
Aspect 30. A system for aggregating employment history on a blockchain network, comprising: a blockchain ledger configured to store employment data in the form of transactions; a smart contract execution environment for deploying and executing employment verification smart contracts; an employment history aggregator configured to compile employment data from the blockchain ledger to form an individual's employment history; and a user interface module configured to display the aggregated employment history to authorized users; wherein the system ensures the integrity and immutability of the employment history through the use of blockchain technology.
Aspect 31. A blockchain-based system for managing and displaying ratings and reviews of employment history, comprising: a ratings module configured to receive and record ratings and reviews for individual employees and employers on a blockchain ledger; a review aggregation module configured to compile and summarize the ratings and reviews associated with each entity; and a display module configured to present the aggregated ratings and reviews to users in a user interface; wherein the ratings and reviews are stored as immutable records on the blockchain, providing a verifiable and tamper-resistant history of feedback.
Aspect 32. The system of any previous Aspect, wherein the ratings module is further configured to: allow for anonymous submission of ratings and reviews while maintaining the credibility and authenticity of the feedback through blockchain-based identity verification mechanisms.
Aspect 33. The system of any previous Aspect, wherein the review aggregation module is further configured to: calculate a composite score for each entity based on the received ratings and reviews; and update the composite score in real-time as new feedback is recorded on the blockchain.
Aspect 34. The system of any previous Aspect, wherein the display module is further configured to: enable users to filter and sort the displayed ratings and reviews based on various criteria such as date, relevance, and score; and provide visual indicators of an entity's reputation trends over time.
Aspect 35. A blockchain-based employment search system, comprising: Aspect 1. a search interface module configured to receive search queries related to employment history and company reputations; a search processing module configured to execute the search queries against a blockchain ledger containing employment data and ratings; and a search results module configured to present the search outcomes to the user, wherein the results include verified employment histories and company reputation summaries; wherein the search functionality is enhanced by the immutable and comprehensive nature of the blockchain-stored data.
Aspect 36. The system of any previous Aspect, wherein the search processing module is further configured to: utilize advanced search algorithms that account for the hierarchical structure of employment data, including company, division, department, team, and project levels.
Aspect 37. The system of any previous Aspect, wherein the search results module is further configured to: display the search results in a ranked order based on relevance to the search query and the composite scores derived from the ratings and reviews; and offer an interactive interface that allows users to refine their search based on additional parameters such as geographic location, employment duration, and specific roles.
Aspect 38. A method for issuing Soul Bound Tokens (SBTs) to employees in a blockchain-based employment verification system, comprising: identifying an employee within a company's organizational structure; generating a unique SBT for the identified employee, wherein the SBT includes employment data comprising at least the employee's job description and job duration; recording the issuance of the SBT on a blockchain ledger, wherein the SBT is associated with the employee's blockchain-based identity; and ensuring that the SBT is non-transferable and immutable once issued.
Aspect 39. The method of any previous Aspect, further comprising verifying the accuracy of the employment data prior to the issuance of the SBT through a multi-step validation process involving employer confirmation and employee acknowledgment.
Aspect 40. The method of Aspect 1, wherein generating a unique SBT further comprises: creating a smart contract that defines the terms and conditions associated with the employee's role and duration of employment; and embedding the smart contract within the SBT to facilitate automated compliance with the terms and conditions.
Aspect 41. The method of any previous Aspect, further comprising providing a mechanism for third-party verification of the SBT, wherein the third party can confirm the authenticity of the employment data without accessing the employee's personal information.
Aspect 42. The method of any previous Aspect, wherein recording the issuance of the SBT on a blockchain ledger further comprises utilizing a consensus algorithm inherent to the blockchain to validate the transaction and permanently record the SBT issuance.
Aspect 43. The method of any previous Aspect, further comprising updating the blockchain ledger to reflect changes in the employee's job description or job duration, while maintaining a historical record of the original SBT issuance.
Aspect 44. The method of any previous Aspect, further comprising integrating the SBT issuance process with existing human resources management systems to automate the generation and recording of SBTs upon employment events such as hiring, promotion, or termination.
Aspect 45. The method of any previous Aspect, wherein the step of generating a unique SBT further comprises encrypting the employment data within the SBT using a public key associated with the employee's blockchain-based identity, wherein the SBT can only be decrypted with a corresponding private key held by the employee.
Aspect 46. The method of any previous Aspect, wherein the step of validating the authenticity of the SBTs further comprises implementing a public-private key encryption mechanism to ensure that only authorized parties can access and verify the employment data within the SBTs.
Aspect 47. The system of any previous Aspect, wherein the smart contract execution environment is further configured to: utilize asymmetric encryption to secure the terms and conditions embedded within the smart contracts, ensuring that only parties with the appropriate decryption keys can execute and enforce the smart contracts.
Aspect 48. The system of any previous Aspect, wherein the blockchain ledger is further configured to: store encrypted employment data using a cryptographic hash function, wherein the hash function provides a secure and tamper-evident record of the employment data.
Aspect 49. The method of any previous Aspect, further comprising generating and managing cryptographic keys for the encryption and decryption of the employment data, thereby enhancing the security and privacy of the data stored on the blockchain ledger.
Aspect 50. The system of any previous Aspect, wherein the user interface module is further configured to: provide a graphical representation of the employee's employment history timeline, including the issuance and duration of each SBT.
Aspect 51. The system of any previous Aspect, wherein the display module is further configured to: enable interactive elements within the user interface that allow users to drill down into specific details of an employee's SBT when selected.
Aspect 52. The system of any previous Aspect, wherein the display module is further configured to: highlight changes in an employee's job description or job duration within the employment history presentation, indicating the historical progression of the employee's career.
Aspect 53. The system of any previous Aspect, wherein the search results module is further configured to: visually differentiate between verified and unverified employment history entries within the search results displayed to the user.
Aspect 54. The system of any previous Aspect, wherein the search interface module is further configured to: provide advanced search options that allow users to perform targeted searches based on specific attributes of the employment data, such as job title, employment period, or employer name.
Aspect 55. The system of any previous Aspect, wherein the search processing module is further configured to: display a visual indicator of the strength of the match between the search query and the search results, such as a relevance score or match percentage.
Aspect 56. The system of any previous Aspect, wherein the search results module is further configured to: offer a comparison view that allows users to compare employment histories or company reputations side-by-side within the user interface.
Aspect 57. The method of any previous Aspect, wherein the multi-step validation process further comprises: a consensus mechanism involving multiple nodes on the blockchain network to validate the accuracy of the employment data before the SBT is issued.
Aspect 58. The method of any previous Aspect, wherein the step of creating a smart contract further comprises incorporating a verification protocol within the smart contract that requires a predetermined number of confirmations from network nodes to execute the terms and conditions.
Aspect 59. The system of any previous Aspect, wherein the search processing module is further configured to: utilize a consensus algorithm to ensure that the search results are derived from the most current and validated version of the blockchain ledger.
Aspect 60. The system of any previous Aspect, wherein the search results module is further configured to: indicate the verification status of each employment history entry based on the consensus reached within the blockchain network.
Aspect 61. The computer-readable medium of any previous Aspect, wherein the instructions further cause the system to: implement a proof-of-stake, proof-of-work, or other consensus protocol to validate new entries and updates to the blockchain ledger, ensuring the integrity of the employment data.
Aspect 62. The computer-readable medium of any previous Aspect, wherein the instructions further cause the system to: execute a dispute resolution protocol within the blockchain network when inconsistencies in the employment data are detected, allowing for corrective actions to be taken based on network consensus.
Aspect 63. The computer-readable medium of any previous Aspect, wherein the instructions further cause the system to: record a log of all consensus activities related to the verification of employment data, providing an auditable trail of the validation process.
Aspect 64. A blockchain-based employment verification system, comprising: a blockchain network configured to store and manage employment data; a plurality of nodes participating in the blockchain network, each node configured to execute smart contracts and validate transactions; a smart contract execution environment within the blockchain network for generating and managing Soul Bound Tokens (SBTs) associated with employees; a user interface module configured to allow employers and employees to interact with the blockchain network and view SBTs; and a verification module configured to validate the accuracy of employment data associated with the SBTs.
Aspect 65. The system of any previous Aspect, wherein the smart contract execution environment is further configured to: generate self-identifying project-factory smart contracts that produce subsidiary-level token collection contracts for the issuance of SBTs.
Aspect 66. The system of any previous Aspect, wherein the blockchain network is further configured to: support a hierarchical structure that allows for the tracking of employment data at multiple organizational levels, including company, division, department, team, and project.
Aspect 67. The system of any previous Aspect, wherein the user interface module is further configured to: display an immutable resume for each employee, comprising a history of SBTs issued to the employee by various employers.
Aspect 68. The system of any previous Aspect, wherein the verification module is further configured to: implement a peer-to-peer employer-employee verification workflow for employment data not initially tracked within the blockchain network.
Aspect 69. The system of any previous Aspect, further comprising: a ratings and reviews module configured to aggregate and store on-chain ratings and reviews associated with employees and employers within the blockchain network.
Aspect 70. The system of any previous Aspect, further comprising: a search module configured to enable querying of the blockchain network for verified employment histories and company reputations based on the SBTs.
Aspect 71. A method for issuing and validating Soul Bound Tokens (SBTs) within a blockchain network, the method comprising: generating, by a smart contract execution environment, a project-factory smart contract for a company within the blockchain network; creating, by the project-factory smart contract, subsidiary-level token collection contracts for entities beneath the company; issuing, by the subsidiary-level token collection contracts, SBTs to employees, wherein each SBT is associated with an employee's job description and job duration; and recording, within the blockchain network, the SBTs to create an immutable record of the employee's affiliation and role with the employer.
Aspect 72. The method of any previous Aspect, further comprising validating, by a verification module within the blockchain network, the authenticity of the SBTs through a multi-step validation process involving consensus among nodes of the blockchain network.
Aspect 73. The method of any previous Aspect, further comprising aggregating, by a ratings and reviews module, on-chain ratings and reviews associated with the employees and employers; and storing, within the blockchain network, the aggregated ratings and reviews to form a synopsis of a job seeker's employment history and a company's reputation as an employer.
Aspect 74. The method of any previous Aspect, further comprising enabling, by a user interface module, employers and employees to interact with the blockchain network to view and manage SBTs associated with their profiles.
Aspect 75. The method of any previous Aspect, further comprising implementing, by the verification module, a peer-to-peer employer-employee verification workflow for employment data not initially tracked within the blockchain network; and updating, within the blockchain network, the employment history of an employee based on the outcome of the peer-to-peer verification workflow.
Aspect 76. The method of any previous Aspect, further comprising providing, by a search module, a search functionality that allows users to query the blockchain network for verified employment histories and company reputations based on the SBTs; displaying, to the users, the search results including verified employment histories and company reputations.

### VI. CLAIMS

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A method for integrating hierarchically linked smart contracts with tokenized verification, the method comprising:
generating a plurality of smart contracts corresponding to a hierarchical structure, each of the plurality of smart contracts being configured for on-chain association between one or more of the following:
a business parent,
a business subsidiary,
a business,
a business division,
a business department,
a business team, and
a business project,
for each of the plurality of smart contracts, defining the following:
one or more triggering events for deployment via a blockchain protocol, and
one or more parameters for minting one or more Soul Bound Tokens (“SBTs”), each of the one or more SBTs being associated with one of the following:
a job hiring,
a review, or
another business project;
responsive to receiving an indication that the one or more triggering events have occurred, identifying a recipient blockchain address associated with the one or more triggering events; and
deploying one or more of the plurality of smart contracts onto the recipient blockchain address corresponding to a user associated with the one or more triggering events.

2. The method of claim 1, further comprising an off-chain controller operatively connected to at least a portion of the plurality of smart contracts, wherein the off-chain controller is configured to receive off-chain commands, and modify, control, and/or manage at least a portion of the plurality of smart contracts based on the off-chain commands.

3. The method of claim 1, wherein at least a portion of the SBT is immutable responsive to the token being deployed.

4. The method of claim 1, wherein a predetermined portion of the SBT is mutable responsive to the token being deployed.

5. The method of claim 4, wherein one or more of the following prompts an alteration of the mutable portion of the SBT:
a job promotion,
a project completion,
a project termination, and
a job termination.

6. The method of claim 1, wherein the SBT, responsive to being deployed, is permanently associated with the blockchain address.

7. The method of claim 1, further comprising minting one or more presentational tokens, each of the one or more presentational tokens minted in parallel to a smart contract related to a business project.

8. The method of claim 1, wherein a termination of one job SBT and the production of another job SBT indicates a job promotion.

9. The method of claim 1, further comprising:
receiving an indication that the one or more parameters have occurred, and
minting the one or more SBTs.

10. A blockchain-based employment verification system comprising:
a plurality of self-identifying project-factory smart contracts configured to generate subsidiary-level token collection contracts;
a token issuance module configured to issue Soul Bound Tokens (SBTs) that associate one or more employees with their respective job descriptions and job durations; and
a verification module configured to track information associated with employee affiliation and employee role for a company based at least in part on the issued SBTs;
wherein the system is configured to accommodate one or more hierarchical structures for each company.

11. The system of claim 10, wherein at least one of the project-factory smart contracts are further configured to produce subsidiary-level token collection contracts for entities beneath a parent company, such that the subsidiary-level token collection contracts specify a subsidiary of the parent company for tracking employment while enabling proof of employment under the parent entity.

12. The system of claim 10, further comprising:
an on-chain rating and review module configured to associate ratings and reviews with each entity within the system;
an employment history aggregation module configured to compile a job seeker's employment history based on the associated ratings and reviews; and
a company reputation synopsis module configured to aggregate and display a company's reputation as an employer based on the ratings and reviews.

13. The system of claim 10, further comprising:
a peer-to-peer employer-employee verification module configured to populate employment data onto the blockchain for employment tracked outside of the system.

14. The system of claim 10, wherein the token issuance module is further configured to issue SBTs that are immutable and non-transferable, thereby creating an on-blockchain resume for each employee.

15. The system of claim 10, wherein the verification module is further configured to:
validate the authenticity of the SBTs and the employment data associated with each token; and
allow one or more third parties to verify an employee work history without compromising employee privacy.

16. The system of claim 10, wherein the system is configured to operate on a public blockchain network, allowing for decentralized access and verification of employment data.

17. A non-transitory computer-readable medium comprising instructions that, when executed by a hardware processor, cause performance of operations for integrating hierarchically linked smart contracts with tokenized verification, the operations comprising:
generating a plurality of smart contracts corresponding to a hierarchical structure, each of the plurality of smart contracts being configured for on-chain association between one or more of the following:
a business parent,
a business subsidiary,
a business,
a business division,
a business department,
a business team, and
a business project,
for each of the plurality of smart contracts, defining the following:
one or more triggering events for deployment via a blockchain protocol, and
one or more parameters for minting one or more Soul Bound Tokens (“SBTs”), each of the one or more SBTs being associated with one of the following:
a job hiring,
a review, or
another business project;
responsive to receiving an indication that the one or more triggering events have occurred, identifying a recipient blockchain address associated with the one or more triggering events; and
deploying one or more of the plurality of smart contracts onto the recipient blockchain address corresponding to a user associated with the one or more triggering events.

18. The computer-readable medium of claim 17, the operations further comprising:
receiving an indication that the one or more parameters have occurred; and
minting the one or more SBTs.

19. The computer-readable medium of claim 17, wherein a predetermined portion of the SBT is mutable responsive to the token being deployed.

20. The computer-readable medium of claim 17, the operations further comprising minting one or more presentational tokens, each of the one or more presentational tokens minted in parallel to a smart contract related to a business project.
